(19) United States
(12) Patent Application Publication
(10) Pub. No.: US 2015/0104539 A1
(43) Pub. Date: Apr. 16, 2015

(54) CITRATED FOLIC ACID COMPOSITIONS AND METHODS FOR DELIVERING FOLIC ACID TO USP DISSOLUTION SPECIFICATIONS

(71) Applicant: Via Naturally, LLC, Fort Myers, FL (US)

(72) Inventor: Rhett Sean Daniels, Fort Myers, FL (US)

(73) Assignee: Via Naturally, LLC, Fort Myers, FL (US)

(21) Appl. No.: 14/053,926

(22) Filed: Oct. 15, 2013

(51) Int. Cl. A23L 1/29

(52) U.S. Cl. CPC A23L 1/296
USPC 426/2; 426/648; 426/72; 426/73; 426/302

(57) ABSTRACT

A composition made of folic acid and at least one citrate buffer, wherein the ratio of folic acid to citrate buffer is from 1:2 to 1:5. A nutritional supplement having a composition made of folic acid, and at least one citrate buffer, wherein the ratio of folic acid to citrate buffer is from 1:2 to 1:5, and a coating. A method of delivering folic acid to a patient according to USP, having the step of administering to a patient a composition comprising a folic acid, and at least one citrate buffer, wherein the ratio of folic acid to citrate buffer is from 1:2 to 1:5, and a coating.

### FIELD

The present disclosure generally relates to compositions made of folic acid and citrate buffers that when used in a nutritional supplement have better absorption in patients and are used to deliver folic acid to patients according to USP.

### BACKGROUND

Folic acid is an important vitamin and plays many roles in providing animals with proper nutrition. Many people with folic acid deficiencies or who need vitamin supplementation take nutritional supplements in an attempt to receive all the nutrients their body's need. Many nutritional supplements provide folic acid, however, many of these supplements are not absorbed well and while people may consume the proper amounts of folic acid, their bodies are not absorbing the sufficient daily nutritional amount.

### SUMMARY

A composition made of folic acid and at least one citrate buffer, wherein the ratio of folic acid to citrate buffer is from 1:2 to 1:5. A nutritional supplement having a composition made of folic acid, and at least one citrate buffer, wherein the ratio of folic acid to citrate buffer is from 1:2 to 1:5, and a coating. A method of delivering folic acid to a patient according to USP, having the step of administering to a patient a composition comprising a folic acid, and at least one citrate buffer, wherein the ratio of folic acid to citrate buffer is from 1:2 to 1:5, and a coating.

### DETAILED DESCRIPTION

The present disclosure will now be described more fully hereinafter, in which some, but not all embodiments of the disclosure are shown. Indeed this disclosure may be embodied in many different forms and should not be construed as limited to the embodiments set forth hereinafter; rather, these embodiments are provided so that this disclosure will satisfy applicable legal requirements

Folic acid has received considerable attention as an essential vitamin. It is widely used in prenatal vitamins to reduce the risk of neural tube defects, but it also holds a prominent position in a multitude of other non-prenatal products. Indeed, as additional research emerges definitively linking homocysteine to varied disease states, it is anticipated that the importance of supplemental folate will be further embraced by the healthcare industry.

FDA on various occasions and in different contexts has asserted that folic-acid containing prenatal vitamins are safe and effective. Further, the best evidence of FDA's affirmation of (conventional) folic acid safety is in its implementation of the US mandatory folic acid food fortification program that was authorized in 1996, and fully implemented in 1998.

Folic acid is important in the prevention of neural tube defects. Studies have assessed the folic acid dissolution performance of commonly prescribed prenatal vitamins and have compared the results with the United States Pharmacopeia (USP) standards. Studies have shown that less than half of prenatal vitamins tested met the USP standard for folic acid dissolution. Average dissolution for the products failing to meet the USP standard ranged from 0% to 38% of labeled amount. These results corroborate findings from other studies suggesting marked differences in dissolution of prescription prenatal vitamins. These findings raise concerns of whether some women could fail to achieve the recommended folate levels needed in early pregnancy to prevent neural tube defects.

Studies show that supplementing a mother's diet with folic acid before and during pregnancy can reduce incidences of neural tube birth defects in children. But other researchers have found poor folic acid dissolution in prenatal prescription multivitamins, raising questions as to whether or not absorption by the body is complete.

Of all of the folates, folic acid is the most widely recognized. Studies have shown that individuals with defective conjugase activity, which is required for absorption of most food-derived polyglutamate folates, have responded better to monoglutamyl folic acid than to dietary folate. However, individuals with genetic polymorphisms for the genes coding methylenetetrahydrofolate reductase (MTHFR) may not be capable of utilizing or metabolizing folic acid adequately for the vitamin B12 dependent methylation cycle.

While studies indicate that folic acid supplements offer promising therapeutic, nutritionally-based approaches to many diseases and medical conditions, some studies also indicate that dissolution failure—that is, the failure of folic acid supplements to meet USP requirements for dissolution—is a significant, concerning problem. One study, for example, showed that over half of the folic acid containing multivitamin supplements tested exhibited dissolution failure. Further, the FDA has recognized this problem and stated:

“With respect to other requirements for health claims on the relationship between folate and risk of NTD's, the agency noted in its final rule of Mar. 5, 1996 (61 Fed. Reg. at 8762), that the benefits of folate intake from food and dietary supplements can only be obtained if the folate is available for absorption and metabolism in the body. Dissolution and disintegration are necessary preconditions for absorption and subsequent metabolism. Digestive processes ensure that conventional foods are digested and that components are liberated for absorption. However, dietary supplements, including folate-containing supplements, can be manufactured in a manner that inhibits dissolution and disintegration (e.g., extremely compressed preparations), and the digestive processes may be insufficient to ensure the liberation of the components for absorption and utilization by the body. A claim on a dietary supplement that does not disintegrate or dissolve would be misleading because the supplement would not meet the preconditions necessary to ensure that the nutrient that is the subject of the claim is available for absorption. For these reasons, the agency adopted §101.79(c)(2)(ii)(B), which states that to bear the folate NTD health claim, dietary supplements must meet the United States Pharmacopeia (USP) standards for disintegration and dissolution, except that if there are no applicable USP standards, the folate in the dietary supplement must be shown to be bioavailable under the conditions of use stated on the product label.”

United States Pharmacopeia establishes written (documentary) and physical (reference) standards for medicines, food ingredients, dietary supplement products and ingredients. These standards are used by regulatory agencies and manufacturers to help to ensure that these products are of the appropriate identity, as well as strength, quality, purity, and consistency.

Every medicament has different solubility properties and pH dependencies which affect its dissolution rate, and hence its bioavailability. Bioavailability can also be affected by a number of factors such as the amounts and types of adjuvants used, the granulation process, compression forces (in tablet manufacturing), surface area available for dissolution and environmental factors such as agitation in the stomach and the presence of food. Due to these numerous factors, specific formulations play an important role in the preparation of prolonged action solid dosage forms, particularly in the preparation of solid dosage forms which achieve appropriate bioavailability for optimum therapeutic effect.

Once a formulation is achieved, the dissolution and disintegration of folic acid is tested to USP. Many times the folic acid does not dissolve and disintegrate to USP and the manufacturers must reformulate the nutritional supplement. Or even worse, the manufacturers do not test the dissolution and disintegration of folic acid and the folic acid in those preparations have minimal absorption and are sub-potent.

The compositions of this disclosure include pellets made of folic acid and a citrate buffer (“citrated folic acid pellets” or “pellets”). The citrated folic acid pellets release folic acid in compliance with USP folic acid dissolution requirements. The citrated folic acid pellets may be added to any nutritional supplement formulation or pharmaceutical preparation and the final product will deliver the folic acid moity to USP. This ensures that a patient is more likely to absorb the folic acid within the nutritional supplement.

The compositions of this disclosure contain a novel form of folic acid—that is, it's conventional folic acid, along with a citrate buffer. In one embodiment, the citrate buffer is trisodium citrate, and in another embodiment it is citric acid. In another embodiment both trisodium citrate and citric acid are used.

The folic acid and the buffer(s) are encapsulated within pellets that dissolve within USP dissolution specification for folic acid.

In one embodiment, the pellets will be available in two sizes -- one suited for inclusion in softgels, and the other for tablets. By adjusting the pH (with the buffers) and targeting the release, this form of folic acid has been optimized for absorption.

In one embodiment, the citrated folic acid pellets are composed of layers. The outermost layer is a coating that delays the release of the inner core ingredients, thereby affecting an initial timed-release effect (about 10 minutes) that helps achieve the goal of releasing the folic acid at the proximal jejunum, where absorption has been shown to be optimal.

Once the outermost layer dissolves, the inner layer, comprised of folic acid and citrate buffers, begins to steadily release. The citrate buffers are used to maintain a constant pH in order to keep the folic acid soluble, even in the case of a highly acidic environment which tends to reduce folic acid's solubility. As a result, folic acid solubility is not affected by gastric contents.

In one embodiment, the pellets have an outer layer. The sifted pellets then transfer for powder layering process using solid drug layering machine. The powder layering can be stand-alone or linked to a fluid bed processor for further sustained release coating or enteric coating to form an integrated pelletization system.

In another embodiment, the outer layer is done by liquid layering. The shifted pellets then transfer for liquid layering process using fluid bed processor machine. The liquid layering linked to fluid bed processor for further sustained release coating or enteric coating to form integrated pelletization system.

In one embodiment, the composition may be made of about 5%-20% trisodium citrate, 2.5%-15% citric acid, and 2.5%-10% folic acid. In one embodiment, composition is made of about 10% sodium citrate, 5% citric acid, and 5% folic acid.

In one embodiment, the trisodium citrate: citric acid range can be from 4:1 to 1.5: 1. In one embodiment, the trisodium citrate: citric acid should be about 2:1

In one embodiment, the total citrate buffer: folic acid range should be should be from 5:1 to about 2:1. In one embodiment, the total citrate: folic acid range should be should be about 3:1. This is important because folic acid must remain soluble in the acidic environment of the stomach in order to be absorbed in the intestine. Studies show that solubility of conventional folic acid decreases with increased acidity.

In one embodiment, 7.5 mg of citrated folic acid pellets contain 2.5 mg folic acid moiety.

In another embodiment, 50 mg of citrated folic acid pellets would yield 2.5 mg of active folic acid. In other words, it is 5% folic acid active.

The trisodium citrate and citric acid, that may be used as buffering agents, should be food grade quality as specified in Food Chemicals Codex. Trisodium citrate and citric acid are merely examples of buffers. Other buffers may be used and would be known to one skilled in the art. For example, phosphate or ascorbate could be used as buffers.

A citrate buffer for use in the present invention may be generated by dissolution of free citric acid or preferably a pharmaceutically acceptable salt of citrate, preferably a sodium salt. Other methods for generating citrate buffers are known in the art.

In one embodiment, the compositions comprise a citrated pteroylglutamate acid controlled release. The citrated folic acid pellets have a multi-phasic release profile in the presence of citrate buffers to adjust the pH for optimal absorption at the proximal jejunum. Providing patients this form of folic acid is distinct from other forms of folic acid because it is formulated to not release until the proximal jejunum, and then releases citrates in order to adjust the pH to the optimal level for metabolization.

Some improvements that the present disclosure provides is unique from conventional folic acid in that it includes buffers to adjust the pH in order to remain soluble in a high acid environment, such as the gastric environment. This is important because folic acid must remain soluble in the acidic environment of the stomach in order to be absorbed in the intestine. Studies show that solubility of conventional folic acid decreases with increased acidity.

In one embodiment, the citrated folic acid pellets may use timed-release technology. The release of folic acid from the pellets is not pH-dependent, meaning the folic acid and citrate buffer(s) will release at the same rate if the intestinal environment is highly acidic or highly alkaline. This is usually not the case in many prior art nutritional supplements.

Another improvement is that the folic acid complies with USP requirements for folic acid dissolution. The USP specification requires that at least 75% of the folic acid dissolve within 60 minutes (in distilled water). The compositions of this disclosure not only comply with USP, but they also meet a tighter specification that requires not less than 85% of folic acid to dissolve between 40-60 minutes. This is intended to target the release of the folic acid at the proximal jejunum, where folic acid absorption has been shown to be maximal.

A GMP and USP certified source of folic acid should be used as a starting material in the manufacture of the compositions of this disclosure. Additionally, the time-release and controlled release citrated-folate pellets would also be useful for folinic acid and formiminoglutamic acid. Folinic acid has a CAS number of CAS 58-05-9 and is otherwise known as formyltetrahydrofolic acid. Formiminoglutamic acid has a CAS number of CAS 816-90-0.

Citric acid is the compound 2-hydroxy-1,2,3-propanetricarboxylic acid. Citric acid has the chemical formula of C₆H₈O₇. It is a naturally occurring constituent of plant and animal tissues. It occurs as colorless crystals or a white powder and may be anhydrous or contain one mole of water per mole of citric acid. Citric acid may be produced by recovery from sources such as lemon or pineapple juice; by mycological fermentation using Candida spp.

Another citrate buffer that maybe used is trisodium citrate. Trisodium citrate has the chemical formula of Na₃C₆H₅O₇. It is sometimes referred to simply as sodium citrate, though sodium citrate can refer to any of the three sodium salts of citric acid. As a conjugate base of a weak acid, citrate can perform as a buffering agent or acidity regulator, resisting changes in pH. Sodium citrate is used to control acidity in some substances,

Method of Making—Example One

Citrated folic acid pellets were designed as a novel controlled-release delivery method to optimize absorption of folic acid. Citrated folic acid pellets encapsulate conventional folic acid, along with citrates, in controlled-release pellets.

The present disclosure also includes making citrated folic acid pellets. The pellets comprise a mixture of citric acid and folic acid. In one embodiment, the pellets contain three part of citric acid and one part of folic acid, and excipients.

The citric acid, folic acid, and excipients are mixed into a raw material mixture. This mixing is the dry mixing. After completion of the dry mixing, solution is added to the raw material mixture for wet mixing. After the wet mixed material is mixed, then the mixed material is ready for extrudation. The mixer can be planetary mixer, rapid mixture granulator, or high shear mixer (top or bottom driven) in the continuous automatic feeding into the extruder feeder hopper, by means of vacuum or screw feeder connection.

Then all wet mass is extruded through extruder into wet pellets. The wet pellets are transferred for spheronization. During this step, cylindrical extrudates (from the previous step) are converted into spheres. Spheronization techniques are known in the art. The extrudates are cut into segments. These segments then collide with the bowl wall and they are thrown back to the inside of the friction plate. Centrifugal force sends the material to the outside of the disc. The action of the material being moved causes the extrudate to be broken down into pieces of approximately equal length related to the diameter of the extrudate. These cylindrical segments are gradually rounded by the collisions with the bowl wall and the plate and each other. These wet pellets should now be rounded.

The extrudates may store in bucket assemblies and discharged into the spherodizer. In one embodiment, it is adjusted to 500 rpm for 5-10 seconds. In one embodiment, 1.0 kg of extruded material is spherodized in lot until the total extrudates are finished. One or more spheronizers are fitted below the buckets assemblies for the collection of a weighed quantity of extrude for the spheronization. These can be fitted with chequered plate having diameter of up to 2000 mm and having configuration of the grooved pattern viz. 0.5-10 mm pitch or as per the diameter of extrudates.

The wet pellets are then transferred for drying in tray dryer. In one aspect, the drying is at 50 +/−5° C. for 8.0 hours +/−5 min. After drying, they are cooled to room temperature and the material is unloaded.

Then the dry pellets are sifted. Sifting the dry pellets ensures that screens are intact with no tears, holes before use. In one embodiment, all wet pellets may be sifted through 16 # mesh followed by 20# mesh on double decked sifter. The material is collected in a clean container.

Then, the shifted pellets may be transferred for a powder layering process. In one embodiment this may be done using a solid drug layering machine. The powder layering can be stand-alone or linked to a fluid bed processor for further sustained release coating or enteric coating to form an integrated pelletization system.

The coated citrated folic acid pellets should then be sifted and put through a mesh on double decked sifter. The material is collected in a clean container. Sieve integrity of sifter before sizing.

Method of Making—Example Two

In another embodiment, the citrated folic acid pellets are made through a different process. Additionally, there are many ways known in the art to mix and make citrated folic acid pellets. The disclosed methods are not a limitation on the manners of making the pellets, but are exemplary of how to make the pellets.

A raw material mixture of citric acid and folic acid and excipients is transferred into a mixer. After completion of dry mixing, solution is added to the material for wet mixing. The wet mixture is then transferred for extrudation.

The wet mass is extruded. The extrudates are transferred for spheronization. The manufacturing machines that make these compositions are known in the art.

The extrudates store in bucket assemblies and are discharged into the spherodizer. This should be adjusted at 500 rpm for 5-10 seconds. In one embodiment, 1.0 kg of extruded material is spherodized in lot until the total extrudates are finished. One or more spheronizers are fitted below the buckets assemblies for the collection of a weighed quantity of extrude for the spheronization. These can be fitted with chequered plate having diameter of up to 2000 mm and having configuration of the grooved pattern viz. 0.5-10 mm pitch or as per the diameter of extrudates.

The wet pellets are then transferred for drying in tray dryer at 50 +/−5° C. for 8.0 hours +/−5 min.

The screens should be ensured to be intact with no tears, holes before use. The wet pellets should be sifted through 16 # mesh followed by 20# mesh on double decked sifter before shifting the dray pellets. The material is then collected in a clean container.

The shifted pellets may then be transferred for liquid layering process using a fluid bed processor machine. The liquid layering linked to fluid bed processor for further sustained release coating or enteric coating to form integrated pelletization system.

In another embodiment, the loaded UFBM bowl may be brought with wet Pellets in position then the bowl may be lifted by pneumatic pressure. Then the pellets may be air blower for 10 minutes. Then the pellets may be heated with setting of inlet at specific temperature. The pellets may be coated.

Then the coated pellets may be sifted through a mesh on double decked sifter. The material is collected in a clean container.

The uncoated pellets would dissolve quickly in an acidic solution. The citrated folic acid pellets may have an outter layer that create a “gap” of time for about 10 or 20 minutes where dissolution is minimal or absent. After the coating has dissolved, then the pellets start to release at a steady rate until complete between 45-60 minutes.

Granulation may be added to the pellets. The granulation effect from the microencapsulation would affect the rate of dissolution, and thus would constitute a time release.

The citrated folic acid pellets are not a final dosage form of folic acid themselves, but rather are used in tablets and softgels. The citrated folic acid pellets may be made into different sized pellets. Typically, the larger pellets would go in to a tablet and the smaller pellets may go into a softgel, strip melt, or gummy. The pellets may contain 2.5%-10% folic acid and citrates, along with other excipients. In one embodiment the pellets are 5% folic acid.

In one embodiment, the pellets do not dissolve in liquid-filled hard or soft capsules. This can be as a result of the polymer-blend of the pellets or more likely because of the coating added to the pellets.

In one embodiment, the pellets are made of sugar, folic acid, trisodium citrate, citric acid, HPMC (hydroxypropyl methylcellulose), and a coloring.

Many colorings are known in the art. Some examples include: beta carotene and beat root colour natural.

In one embodiment, the particle size for using in tablet should be mostly 100% passing 40 US mesh. In another embodiment, not less than 90% pellets should pass through 40 US mesh; and no more than 10% should pass through 60 US mesh.

In one embodiment, the particle size for using in softgel should be mostly 100% passing 60 US mesh, and about none passing through 80 US mesh. In another embodiment, no less than 90% pellets should pass through 60 US mesh, and no more than 10% should pass through 80 US mesh. The polymers used in the granulation should not swell in oil and lecithin. Any swelling inside softgel could cause leaking problem.

Most embodiments are granular and even the larger pellets that have 50% pass through 60 US mesh may used for tablet compressing. Smaller pellets are harder to be broken than bigger pellets. So during tablet compressing, it's hard to know how much could be broken.

In one embodiment, not less than 90% pellets should pass through 80 US mesh; and, no more than 10% pellets should pass through 120 US mesh. This embodiment is good for softgels.

In one embodiment, not less than 90% pellets should pass through 40 US mesh; no more than 10% pellets should pass through 60 US mesh.

Some embodiments of the citrated folic acid pellets may be accommodated for gummy vitamins. Other embodiments of the citrated folic acid pellets may be accommodated for strip melts. In some embodiments the pellets may be used in capsules.

Most nutritional supplements simply add raw material folic acid in addition with other vitamins and minerals. Each time a different nutritional supplement is made, it must be tested whether or not the folic acid is made to USP, that is to say, it dissolves and disintegrates according to USP protocols. Therefore, supplement manufacturers many times will have to try various manufacturing protocols-changing the manner in which they formulate a supplement to ensure folic acid is delivered to USP. If a product is reformulated by adding a new ingredient, then the manufacture will need to retest the folic acid dissolution to ensure it meets USP.

The USP section describes monograph test methods for vitamins and calcium supplements. Testing is based on the product's end use and strength. For example, if a calcium product is a compendial article and will be used as an antacid, the test is a disintegration test. However, if the article will be used as a calcium supplement for the treatment of osteoporosis, the test is a dissolution method. Because manufacturers have no control over a product's end use, it becomes their responsibility to see that a tested product would pass both disintegration and dissolution tests throughout its shelf life. Additionally, if the product is labeled “USP,” it must be packaged, stored, and distributed as required in the monographs and in conformance with USP General Chapters. It should be noted that nutraceutical manufacturers are not required to meet USP monograph standards in order to market their products. However, use of a USP label claim on the product does require this, and failure to pass these standards would then be considered as “product mislabeling or misbranding”, a punishable violation of FDA guidelines.

In one embodiment, the citrated folic acid pellets are hard, brittle, free- flowing, golden yellow coloured pellets. The UV absorption spectrum of sample solution exhibits maxima and minima at the same wave length as that of similar solution of USP Folic acid RS Concomitantly measured. The absorption ratio A256/A365 is 2.80-3.0.

The citrated folic acid pellets of the present disclosure allow a manufacturer to use any formulation and simply add the citrated folic acid pellets without having to change the formulation methods to get the folic acid to dissolve and disassociate according to USP because the compositions of the present disclosure do.

This is most important if a product is going to make a folic acid related health claim, it must comply with USP. Nutritional supplements using the citrated folic acid pellets will all be able to comply with health claims regardless of the medium of delivery or interference from other minerals and vitamins, excipients etc.

Typically vitamins, including folic acid, are more readily absorbed in the upper gastrointestinal tract, just beyond the stomach. When many vitamin products do not meet the standard of dissolving within an hour, there is a potential problem with these products. The amount of folic acid available for optimal absorption in the body could be inadequate.

While dissolution of a substance does not guarantee absorption, it is necessary for absorption to occur. Many products miss the minimum standard by a wide margin, some even releasing less than 25 percent of the labeled quantity.

While some products and some manufacturers have improved their products to insure proper dissolution since this problem became known in the 1990s, many products still do not meet USP.

For drugs it is standard to analyze blood levels to make sure the substance is absorbed. A manufacturer must substantiate purity, safety and efficacy with data in a drug application to the FDA.

Scientifically much is known about how drugs are absorbed by the body, but there have been little research into bioavailability from vitamin tablets or capsules.

Nutritional supplements having citrated folic acid pellets may also include: Vitamin B₁₂, B₆, Magnesium, Iron, B₂, Vitamin C, B₅/Pantethine/Coenzyme A, Omega-3, Vitamin D, Zinc, Reduced Vitamin B₉. Nutritional supplements having citrated folic acid pellets may be used for prenatal vitamins as folic acid is important in pregnancy. Therefore, in one embodiment citrated folic acid pellets will be used in nutritional vitamins along with the following vitamins and minerals.

Vitamin B₁₂ is essential for appropriate folic acid metabolism, which is why including Vitamin B₁₂ in a nutritional supplement with citrated folic acid would be beneficial. When a person is deficient in Vitamin B₁₂, it may be noted by megaloblastic anemia. Vitamin B₁₂ also plays a role in maintaining cellular integrity of the central nervous system. Therefore, while supplementation of folic acid may cure hematologic symptoms (anemia) of B₁₂ deficiency, it will leave a fetus vulnerable to central nervous system damage. Vitamin B₁₂ is found exclusively in animal tissues hence during pregnancy a vegan woman is at risk for B₁₂ deficiency. Vitamin B₁₂, may be provided as cyanocobalamin to mitigate any deficiency of this essential vitamin.

Vitamin B₆ is a water-soluble vitamin and is part of the vitamin B complex group. Vitamin B₆ is a cofactor in many reactions of amino acid metabolism, including transamination, deamination, and decarboxylation. The primary role of vitamin B₆ is to act as a coenzyme to many other enzymes in the body that are involved predominantly in metabolism. This role is performed by the active form, pyridoxal phosphate. Pyridoxal phosphate-dependent enzymes play a role in the biosynthesis of five important neurotransmitters: serotonin, dopamine, epinephrine, norepinephrine, and gamma-aminobutyric acid (GABA).

Magnesium is may be supplemented to prevent pre-eclampsia, preterm rupture of the membranes, and preterm births secondary to early labor. Women who deliver preterm are more likely to have lower plasma levels of this mineral.

Iron is necessary for blood formation of the fetus and placenta. Iron depletion and iron deficiency anemia are the most common deficiency in pregnancy (90% of all anemias). Growth restriction, preterm delivery, and pre-eclampsia have been noted in women who have iron deficiency.

Vitamin B₂ deficiency has been associated with fetal malformation of the bony tissue and membranous skeleton, which precedes the cartilageous and osseous skeletons. Proper nutrition of Vitamin B₂ is also important to prevent hyperemesis gravidarum and an increased incidence of growth restriction and preterm delivery in the fetus. Maternal deficiency of Vitamin B₂ is associated with stomatitis, glossitis and cheilosis.

Ascorbic acid (Vitamin C) is essential for the formation of collagen and therefore is very important for both mother and fetus during pregnancy. The transport mechanism across the placenta is the same for that of glucose therefore Vitamin C supplementation is very important in those women having (or at risk for) diabetes.

Vitamin B₅/pantethine/coenzyme A: Pantothenic acid is an essential nutrient. Animals require pantothenic acid to synthesize coenzyme-A (CoA), as well as to synthesize and metabolize proteins, carbohydrates, and fats. Pantothenic acid participates in a wide array of key biological roles, it is essential to all forms of life.

Omega-3 fatty acids may be found in marine fats. They have been shown to be important in the prevention of pre-eclampsia, preterm delivery, and early rupture of the membranes. Enhanced cognitive function and improved visual acuity in babies born to mothers supplemented with docosahexaenoic acid (DHA) have also been noted. There has been a decrease in maternal postpartum depression when supplemented with DHA. Cold water fish are the highest dietary sources of DHA and it is also available in the eggs of chickens supplemented with micro-algae.

Vitamin D regulates calcium homeostasis by maintaining equilibrium (along with parathormone) between calcium resorption and excretion. If Vitamin D levels are low, then the mother may lose significant calcium in her urine. If maternal calcium intake is low, then poor bone mineralization is likely to occur in infants. Vitamin D may be in the form of Vitamin D₃ or cholecalciferol.

Proper Zinc nutrition helps prevent congenital malformations as well as fetal losses. Since maternal plasma levels of zinc decrease during pregnancy, supplementation is important. In the fetus, deficiency of zinc may be involved with premature rupture of the membranes and a reduced ability to fight infection due to suppressed immunity.

Reduced Vitamin B_{9:}The health benefits and even requirements of folic acid have been discussed previously. In addition to folic acid, reduced folates are also beneficial for some people's nutrition. Folic acid is the most oxidized state of Vitamin B₉. Reduced folates are more bioactive and are more readily available for the cells to use. A combination of folic acid with reduced folates has shown to have a synergistic effect.

Other embodiments for folic acid supplementation include:

### Example One

Citrates plus 60-80% of folic release btw 30-60 minutes and not less than 90% pellets pass through 40# mesh.

The potency is 5.4% folic acid, dissolution is 100% release within 1 hour. They all meet supplier's CoA.

The media that was be chosen in folic acid tablet dissolution test according USP folic acid monograph, was a citrate buffer solution, because folic acid does not completely dissolve in water.

### Example Two

Citrated Folic Acid Pellets were tested.
1. in 0.1 N HCL (highly acidic 3.5 PH) at 10, 20, 30, 45, & 60 minutes.
1. in water (7 PH) at 10,20,30,45, & 60 minutes.
1. in buffer (highly alkaline 7.8 PH) at 10, 20, 30, 45, & 60 minutes.
   Citrated Folic Acid pellets 5.0%w/w

| | Time: | 0.1M Hcl | Water | Buffer |
|---|---|---|---|---|
| Dissolution | 10 Min | 26.24% | 25.76% | 95.2% |
| l | 20 Min | 29.53% | 27.50% | 96.8% |
| RPM: 75 | 30 Min | 76.1% | 78.2% | 97.2% |
| Appartus: USP II (Paddle) | 45 Min | 90.27% | 90.29% | 98.2% |
| Medium 900 ml | 60 Min | 93.1% | 93.5% | 99.1% |

| | | | |
|---|---|---|---|
| Assay | | | |
| Composition | 1.A | Est A | % of LA |
| Folic acid | 5% | 4.99% | 99.85% |
| | | | (limt 90% to 110%) |

### Example Three

In one embodiment, the citrated folic acid pellets have a concentration of 5% w/w. These specially formulated pellets are targeted to yield better release profile than the other dietary supplement containing folic acid that are currently marketed in the US. The product is deemed to meet USP Specifications for the dissolution test. As described, the USP specification for Folic Acid Dissolution is as follows:

Acceptance Criteria: Not Less than 75(Q) is dissolved in 45 minutes.

Acceptance Table 1

| Stage | | |
|---|---|---|
| Number | Tested | Acceptance Criteria |
| S1 | 6 units | Each unit is not less than Q + 5%. S2 6 units |
| S2 | 6 units | Average of 12 units (S1 + S2) is equal to or greater than |
| | | Q, and no unit is less than Q 15%. |
| S3 | 12 units | Average of 24 units (S1 + S2 + S3) is equal to or greater |
| | | than Q, not more than 2 units are less than Q 15%, and |
| | | no unit is less than Q 25%. |

Dissolution tests were performed by weighing out different sample sizes as specified in the table below for each of the test conditions that were verified. The first test was conducted by using the exact test conditions described under Dissolution <711> for Folic Acid Tablets as these pellets were similar to micro tablets consisting of Sugar, Folic Acid, Sodium citrate, Citric Acid, HPMC and a coloring which essentially is similar to micro tablets.

Dissolution Tests of one example are shown below:

Specifications (Folic Acid Tablets):
Not Less Than 75% (Q) is dissolved in 45 minutes.
Apparatus: 2 (Paddles)

| | | | | |
|---|---|---|---|---|
| Sample | Test Conditions: | Test Condition#1: | Test Condition#2: | Test Condition#3: |
| Number | Medium: Water | Medium: Water | Medium: Water | Medium: Water |
| | Volume: 500 mL | Volume: 500 mL | Volume: 500 mL | Volume: 900 mL |
| | Apparatus: 2 | Apparatus: 2 | Apparatus: 2 | Apparatus: 2 |
| | Time: 1 hr | Time: 45 minutes | Time: 45 minutes | Time: 1 hr |
| | Speed: 50 RPM | Speed: 50 RPM | Speed: 50 RPM | Speed: 75 RPM |
| | Sample size: | Sample Size: | Sample Size: | Sample Size: |
| | 350 mg | 100 mg | 350 mg | 100 mg |
| | Label Claim: 3% | Label Claim: 5% | Label Claim: 3% | Label Claim: 5% |
| | w/w | w/w | w/w | w/w |
| G13037 | 85.6% | 94% | 100% | 95% |
| (5% w/w) | | | | |

It should be emphasized that the embodiments described herein are merely possible examples of implementations, merely set forth for a clear understanding of the principles of the present disclosure. Many variations and modifications may be made to the described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

One should note that conditional language, such as, among others, “can,” “could,” “might,” or “may,” unless specifically stated otherwise, or otherwise understood within the context as used, is generally intended to convey that certain embodiments include, while alternative embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment. Unless stated otherwise, it should not be assumed that multiple features, embodiments, solutions, or elements address the same or related problems or needs.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

1. A nutritional supplement comprising:
pellets, wherein the pellets comprise: a folic acid, and at least one citrate buffer, wherein the ratio of folic acid to citrate buffer is from 1:2 to 1:5 by weight, wherein at least 75% of the folic acid dissolves within 60 minutes from when of the nutritional supplement enters a relevant solvent.

2. (canceled)

3. The nutritional supplement of claim 1, wherein the pellets further comprising comprise an outer layer.

4. The nutritional supplement of claim 1, wherein the citrate buffer is trisodium citrate.

5. The nutritional supplement of claim 1, wherein the citrate buffer is citric acid.

6. The nutritional supplement of claim 1, wherein the citrate buffer is a mixture of trisodium citrate and citric acid.

7. (canceled)

8. The nutritional supplement of claim 1, wherein at least 85% of folic acid dissolves between 40-60 minutes from when the nutritional supplement enters the relevant solvent.

9. The nutritional supplement of claim 1, wherein the pellets have a mesh size of about 60.

10. The nutritional supplement of claim 1, wherein the pellets have a mesh size of about 80.

11. The nutritional supplement of claim 1, wherein the pellets have a mesh size of about 120.

12. The nutritional supplement of claim 1, wherein the pellets do not dissolve in liquid-filled hard or soft capsules.

13. (canceled)

14. (canceled)

15. The nutritional supplement of claim 1, wherein the nutritional supplement is in softgel form.

16. The nutritional supplement of claim 1, wherein the nutritional supplement is in tablet form.

17. The nutritional supplement of claim 1, wherein the nutritional supplement is in capsule form.

18. The nutritional supplement of claim 1, further comprising at least one vitamin selected from Vitamin B₁₂, Vitamin B₆, Vitamin B₂, Vitamin C, B₅/Pantethine/Coenzyme A, Omega-3 fatty acid, Vitamin D, and/or a reduced Vitamin B_{9;}
and at least one mineral selected from Magnesium, Iron, and/or Zinc.

19. The nutritional supplement of claim 1, further comprising DHA.

20. A method of delivering folic acid to a patient according to USP dissolution specifications, the method comprising the steps: administering to a patient a nutritional supplement, wherein the nutritional supplement contains pellets that comprise a folic acid and at least one citrate buffer, wherein at least 75% of the folic acid dissolves within 60 minutes of administering the nutritional supplement to a patient.

21. The method of claim 20, wherein the ratio of folic acid to citrate buffer is from 1:2 to 1:5 by weight.

22. The method of claim 20, wherein the pellets further comprise an outer layer.

23. The method of claim 20, wherein the nutritional supplement is a liquid-filled hard or soft capsules and the pellets do not dissolve in the liquid-filled hard or soft capsules.

24. (canceled)

25. (canceled)

26. (canceled)

27. The composition of claim 1, wherein the relevant solvent is distilled water.

28. The composition of claim 1, wherein the relevant solvent is saliva, gastric fluid, or intestinal fluid.

29. A nutritional supplement comprising:
at least one vitamin, and
pellets, wherein the pellets comprise: a folic acid, and at least one citrate buffer, wherein at least 75% of the folic acid dissolves within 60 minutes of administering the nutritional supplement to a patient.

30. The nutritional supplement of claim 29, wherein the ratio of folic acid to citrate buffer is from 1:2 to 1:5 by weight.

31. The nutritional supplement of claim 1, wherein the solvent is 900 ml of water at 37° C.
